(19) United States
(12) Patent Application Publication
(10) Pub. No.: US 2021/0278945 A1
(43) Pub. Date: Sep. 9, 2021

(54) TOUCH SYSTEM AND ELECTRONIC DEVICE

(71) Applicant: GOERTEK INC., Weifang City, Shandong (CN)

(72) Inventors: Zhongkai LI, Weifang City, Shandong (CN); Wentao WANG, Weifang City, Shandong (CN); Tianduo ZHOU, Weifang City, Shandong (CN)

(21) Appl. No.: 16/319,519

(22) PCT Filed: Dec. 19, 2016
(86) PCT No.: PCT/CN2016/110697

§ 371 Date: Jan. 22, 2019

(30) Foreign Application Priority Data
Jul. 22, 2016 (CN) 201620783067.1

(51) Int. Cl. G06F 3/041

(52) U.S. Cl. CPC G06F 3/04142; G06F 3/044; G06F 3/0416

(57) ABSTRACT

A touch control system and electronic device, said touch control system comprising a touch control element (110), a touch control sensor apparatus (120), an analog-to-digital converter unit (130), a digital signal processing unit (140), and a function regulating unit (150), wherein said touch control sensor apparatus (120) is provided with a first pressure sensor (10) and a second pressure sensor (20). Said touch control sensor apparatus (120) is configured to convert swiping actions of a user on the touch control element (110) into an analog voltage signal, said analog-to-digital converter unit (130) is configured to convert the analog voltage signal into a digital signal; said digital signal processing unit (140) is configured to calculate swiping pressure information and position information on the basis of the digital signal, said function regulating unit (150) regulates corresponding functions on the basis of the swiping pressure information and position information. By using a touch control swiping method, functions of an electronic device may be regulated, allowing for a side button of a mobile phone to be swiped.

### TECHNICAL FIELD

The present disclosure relates to the field of electronic technology and more particularly to a touch system realizing a functional regulation based on a sliding touch operation and an electronic device.

### BACKGROUND

Currently, most electronic products adopt a mechanical key design. Due to the necessity of keys for consumer electronic products such as a mobile phone, a PAD and a watch, the mechanical key design with a complicated forming process brings about a heavy workload to product assemblies, mold processes, etc.

Moreover, the mechanical key has relatively less functions. With continuous development of the electronic information technology, user demands on functions of an electronic device are increasing, and simultaneously miniaturization and integration of hardware, simplification of housing and assembly, etc are required.

Thus, the prior art needs to be improved to solve at least one of the above problems.

### SUMMARY

An objective of the present disclosure is to provide a touch system, so that a user can carry out a functional regulation by means of a corresponding sliding touch operation.

According to one aspect of the present disclosure, there is provided a touch system, comprising a touch element, a touch sensing device, an analog-to-digital conversion unit, a digital signal processing unit and a function regulating unit. The touch sensing device is provided with a first pressure sensor and a second pressure sensor and configured to convert a sliding movement on the touch element by a user into an analog voltage signal. The analog-to-digital conversion unit is configured to convert the analog voltage signal into a digital signal. The digital signal processing unit is configured to evaluate pressure information and location information of the sliding movement based on the digital signal. The function regulating unit is configured to regulate a corresponding function based on the pressure information and the location information of the sliding.

Optionally, the touch element is a touch sensing bar. The touch sensing bar and the touch sensing device are respectively provided on an outer surface and an inner surface of a lateral plate of an electronic device housing.

Optionally, two identifiers are d provided on the touch sensing bar and respectively correspond to the first pressure sensor and the second pressure sensor of the touch sensing device.

Optionally, the touch sensing device is provided on a circuit board. The first pressure sensor and the second pressure sensor are respectively located at two ends of the circuit board.

Optionally, the pressure sensor is a piezoresistive sensor, a capacitive sensor or an inductive sensor.

Optionally, the function regulating unit comprises at least one function of volume adjustment, focal length setting, page turning and wheel scrolling.

Optionally, the touch sensing device further comprises two buffer parts respectively provided on the first pressure sensor and the second pressure sensor.

Optionally, the buffer parts are made of silicone rubber.

Optionally, the touch system further comprises a mainboard provided in the electronic device housing. The analog-to-digital conversion unit, the digital signal processing unit and the function regulating unit are all located on the mainboard.

According to a second aspect of the present disclosure, there is provided an electronic device, comprising a touch system according to the present disclosure.

One technical effect of the present disclosure is to provide a sliding touch based key design, so that the functions of volume adjustment, page turning and the like could be achieved by means of touches.

Further features of the present disclosure and advantages thereof will become apparent from the following detailed description of exemplary embodiments according to the present disclosure with reference to the attached drawings.

### BRIEF DESCRIPTION OF THE DRAWINGS

The accompanying drawings, which are incorporated in and constitute a part of the specification, illustrate embodiments of the disclosure and, together with the description thereof, serve to explain the principles of the disclosure.

FIG. 1 is a schematic block diagram of modules of a touch system according to the present disclosure.

FIG. 2 is a schematic diagram of a touch sensing device of the touch system according to the present disclosure.

FIG. 3 is a schematic diagram of a touch element according to the present disclosure.

FIG. 4 is a schematic diagram for explanation of a touch sensing principle according to the present disclosure.

### DETAILED DESCRIPTION

Various exemplary embodiments of the present disclosure will now be described in detail with reference to the drawings. It should be noted that the relative arrangement of the components and steps, the numerical expressions, and numerical values set forth in these embodiments do not limit the scope of the present disclosure unless it is specifically stated otherwise.

The following description of at least one exemplary embodiment is merely illustrative in nature and is in no way intended to limit the disclosure, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

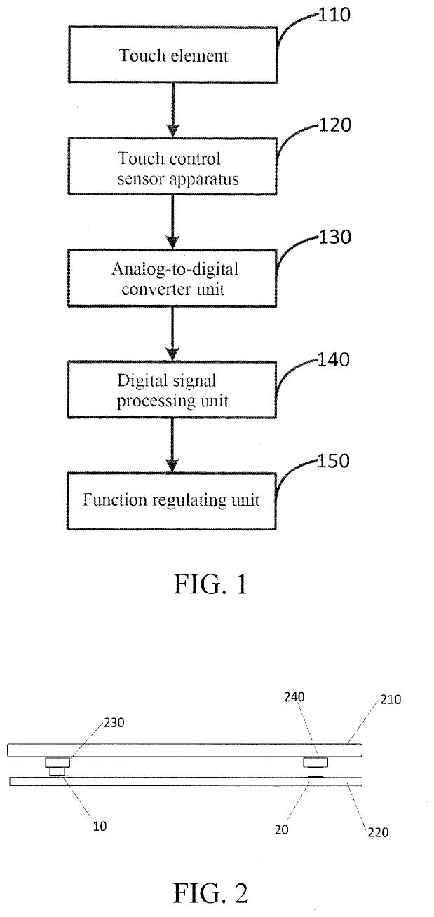

FIG. 1 is a schematic block diagram of functional modules of a touch system according to the present disclosure.

As shown in FIG. 1, in an embodiment, the touch system comprises a touch element 110, a touch sensing device 120, an analog-to-digital conversion unit 130, a digital signal processing unit 140 and a function regulating unit 150, and could be applied to electronic devices such as a mobile phone.

The touch sensing device 120 is provided with a first pressure sensor and a second pressure sensor and configured to convert a sliding movement on the touch element 110 by a user into an analog voltage signal.

The touch element 110 could be provided in an appropriate area of an electronic device. For example, to make it convenient for the user to operate, the touch element 110 is provided on the top right side of a keyboard area of a PAD. The user could trigger a functional regulation by means of sliding in opposite directions on the touch element 110. For example, a volume is increased in case of upward sliding and reduced in case of downward sliding. Other functional regulations are similar.

In an example, the touch element 110 is a touch sensing bar. The touch sensing bar and the touch sensing device 120 are respectively provided on an outer surface and an inner surface of a lateral plate of an electronic device housing. For example, the touch sensing bar is provided on an outer surface of a lateral plate of a mobile phone, which is seldom touched by the user, e.g., in a volume adjustment position on the lateral plate of the mobile phone in the prior art. Owing to this design, the user could conveniently perform a sliding-based regulation. Meanwhile, to some extent, the user could be prevented from incorrectly triggering the functional regulation by an unintentional sliding touch.

In another example, to make it convenient for the user to visually learn about meanings of different sliding directions, two identifiers are disposed on the touch sensing bar, corresponding to the first pressure sensor and the second pressure sensor on the touch sensing device 120 respectively. For example, an identifier “+” corresponds to a location of the first pressure sensor, and an identifier “−” corresponds to a location of the second pressure sensor. That is, a sliding toward “+” indicates that an increase (e.g, volume increase) is needed, and a sliding toward “−” indicates a reduction (e.g, volume reduction) is needed.

Optionally, the touch sensing device is provided on a circuit board. The first pressure sensor and the second pressure sensor are respectively located at two ends of the circuit board. Locations of the two pressure sensors and a distance therebetween are set based on a size of the circuit board, a usual sliding distance of the user and sensing sensitivities of the two pressure sensors.

To prevent the pressure sensors from being damaged by frequent or violent slidings of the user, the touch sensing device 120 could be further provided with two buffer parts, which are respectively provided on the first pressure sensor and the second pressure sensor to prolong a service life of the two pressure sensors. The buffer parts could be made of some common buffering plastic materials, e.g., silicone rubber.

Optionally, the pressure sensor is a piezoresistive sensor, a capacitive sensor or an inductive sensor.

The analog-to-digital conversion unit 130 is configured to convert the analog voltage signal into a digital signal.

The digital signal processing unit 140 is configured to evaluate pressure information and location information of a sliding based on the digital signal.

The function regulating unit 150 is configured to regulate a corresponding function based on the pressure information and the location information of the sliding.

Optionally, the function regulating unit 150 comprises at least one function of volume adjustment, focal length setting, page turning and wheel scrolling. For example, when browsing a web page, the user could perform a sliding on the touch element 110 to trigger the wheel scrolling function, so as to facilitate reading. For example, when reading an e-book, the user could perform a sliding on the touch element 110 for page turning. Other functions are similar.

The analog-to-digital conversion unit 130, the digital signal processing unit 140 and the function regulating unit 150 could be provided on a mainboard in the electronic device housing. In another example, a main control unit is further provided on the mainboard and could coordinate other units or modules on the mainboard.

In the embodiment, the touch system operates based on following basic principles: the user performs a sliding on the touch element 110; after sensing a sliding pressure, the two pressure sensors disposed on the touch sensing device 120 output a differential voltage to the analog-to-digital conversion unit 130; the analog-to-digital conversion unit 130 converts the differential voltage into a digital signal, e.g., an I2C digital signal, and sends the digital signal to the digital signal processing unit 140; the digital signal processing unit 140 evaluates the amount and location of the pressure based on the received digital signal; and the function regulating unit 150 regulates a corresponding function based on the pressure information and the location information. For example, a proportional conversion into a functional regulation is performed by the function regulating unit 150 based on the location information and the pressure information of the corresponding sliding, such as a volume increase or reduction, a camera focal length increase or reduction, a page turning and a wheel scrolling. The function regulating unit 150 may be a system software, an APP software or the like.

The touch system provided by the present disclosure could be disposed in an electronic device, so that a function could be regulated by means of a corresponding sliding touch operation. The electronic device comprises but not limited to a mobile phone, a camera, a game machine and its controller, a headset, a computer, a watch, a pair of glasses, a PAD, a Smart home, etc.

To sum up, a touch key design is realized by the pressure sensors without a mechanical key. Thus, a better user experience could be provided.

FIG. 2 is a schematic diagram of the touch sensing device of the touch system according to the present disclosure.

FIG. 2 schematically illustrates the housing 210, the circuit board 220, the first pressure sensor 10, the second pressure sensor 20, the first buffer part 230 and the second buffer part 240 of the electronic device.

In the embodiment, the circuit board 220 bears the touch sensing device and is strip-shaped. The first pressure sensor 10 and the second pressure sensor 20 are respectively located at the two ends of the circuit board 220. To protect the pressure sensors, FIG. 2 also illustrates the two buffer parts, namely, the first buffer part 230 and the second buffer part 240. The two buffer parts are slightly greater than the pressure sensors in size and are in direct contact with the housing when the touch sensing device is mounted in the housing of the electronic device.

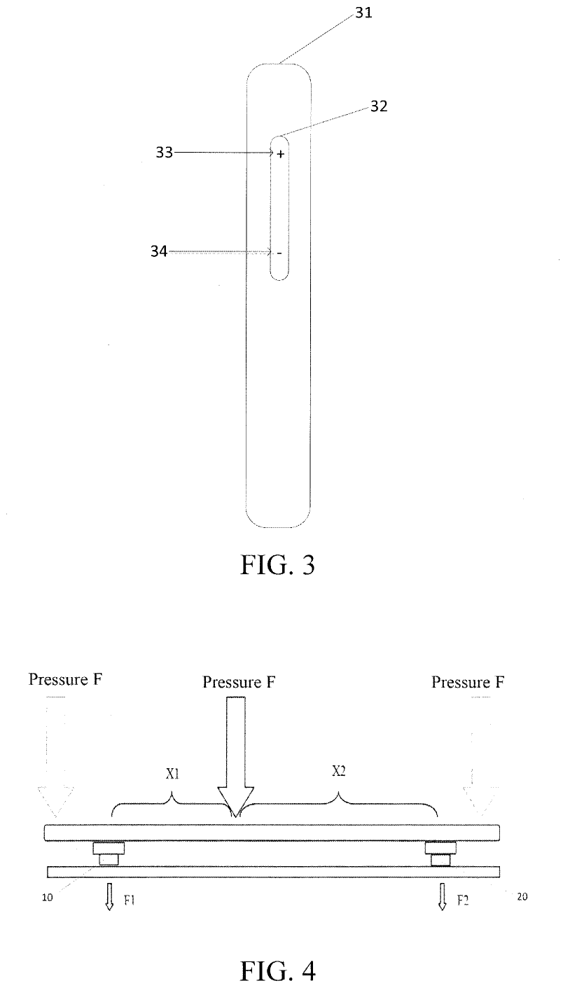

FIG. 3 is a schematic diagram of the touch element according to the present disclosure. The mobile phone is taken as an example for explanation.

As shown in FIG. 3, the touch element comprises the lateral plate 31 of the mobile phone and the touch sensing bar 32. The two identifiers, namely, the first identifier 33 and the second identifier 34, are disposed on the touch sensing bar 32.

In the embodiment, the touch sensing bar 32 is the touch element according to the present disclosure, is substantially strip-shaped and is disposed on the outer surface of the lateral plate of the mobile phone. With reference to FIG. 2, it can be known that the touch sensing device, namely the circuit board 220 in FIG. 2, could be mounted on the inner surface of the lateral plate of the mobile phone and corresponds to the touch sensing bar. The first identifier 33 and the second identifier 34 respectively correspond to the two pressure sensors on the circuit board 220. Thus, when the user performs a sliding in a direction along the two identifiers, the pressure sensors could sense a pressure generated by the sliding.

FIG. 4 is a schematic diagram for explanation of a touch sensing principle according to the present disclosure.

The touch sensing principle according to the present disclosure could be understood better based on FIG. 4. As shown in FIG. 4, a pressure sensed by the first pressure sensor 10 is marked with F1, and a pressure sensed by the second pressure sensor 20 is marked with F2. When a pressure point F is located between the first pressure sensor 10 and the second pressure sensor 20, the amount and location of an actual pressure could be obtained according to a ratio of the pressure F1 to the pressure F2, i.e. F=F1+F2, F1/F2=X2/X1. X1 is a distance between the pressure point F and the first pressure sensor 10. X2 is a distance between the pressure point F and the second pressure sensor 20.

Similarly, when a pressure point F is located at a left end of the first pressure sensor 10, a pressure of the first pressure sensor 10 is a positive pressure, and a pressure of the second pressure sensor 20 is a negative pressure. The amount and location of a current actual pressure could be obtained according to a ratio of the pressure F1 to the pressure F2.

Similarly, when a pressure point F is located at a right end of the second pressure sensor 20, a pressure of the first pressure sensor 10 is a negative pressure, and a pressure of the second pressure sensor 20 is a positive pressure. The amount and location of a current actual pressure could be obtained according to a ratio of the pressure F1 to the pressure F2.

To sum up, since the two pressure sensors constitute the touch system, a touch-based function could be designed and extended in such manner that a sliding, a semi-sliding, a forced-press sliding and a slight-press sliding can trigger respective functions. A touch-based regulation unit could trigger a regulation of a corresponding function by means of a continuous variation of a pressure ratio in a sliding process. Therefore, the touch system could achieve an effect that could not be achieved by a traditional mechanical key, thus providing a new experience for the user.

Although some specific embodiments of the present disclosure have been demonstrated in detail with examples, it should be understood by a person skilled in the art that the above examples are only intended to be illustrative but not to limit the scope of the present disclosure. It should be understood by those skilled in the art that the above embodiments could be modified without departing from the scope and spirit of the present disclosure. The scope of the present disclosure is defined by the appended claims.

1. A touch system, comprising a touch element, a touch sensing device, an analog-to-digital conversion unit, a digital signal processing unit and a function regulating unit, wherein the touch sensing device is provided with a first pressure sensor and a second pressure sensor and configured to convert a sliding movement on the touch element by a user into an analog voltage signal; the analog-to-digital conversion unit is configured to convert the analog voltage signal into a digital signal; the digital signal processing unit is configured to evaluate pressure information and location information of the sliding based on the digital signal; and the function regulating unit is configured to regulate a corresponding function based on the pressure information and the location information of the sliding.

2. The touch system according to claim 1, wherein the touch element is a touch sensing bar, and the touch sensing bar and the touch sensing device are respectively provided on an outer surface and an inner surface of a lateral plate of an electronic device housing.

3. The touch system according to claim 2, wherein two identifiers are provided on the touch sensing bar and respectively correspond to the first pressure sensor and the second pressure sensor of the touch sensing device.

4. The touch system according to claim 1, wherein the touch sensing device is provided on a circuit board, and the first pressure sensor and the second pressure sensor are respectively located at two ends of the circuit board.

5. The touch system according to claim 1, wherein the pressure sensor is a piezoresistive sensor, a capacitive sensor or an inductive sensor.

6. The touch system according to claim 1, wherein the function regulating unit comprises at least one function of volume adjustment, focal length setting, page turning and wheel scrolling.

7. The touch system according to claim 1, wherein the touch sensing device further comprises two buffer parts respectively provided on the first pressure sensor and the second pressure sensor.

8. The touch system according to claim 7, wherein the buffer parts are made of silicone rubber.

9. The touch system according to claim 2, further comprising a mainboard provided in the electronic device housing, wherein the analog-to-digital conversion unit, the digital signal processing unit and the function regulating unit are all located on the mainboard.

10. An electronic device, comprising a touch system of claim 1.
